(19) United States
(12) Patent Application Publication
(10) Pub. No.: US 2011/0187511 A1
(43) Pub. Date: Aug. 4, 2011

(54) METHOD AND APPARATUS FOR MANAGING CONTENT, CONFIGURATION AND CREDENTIAL INFORMATION AMONG DEVICES

(75) Inventors: Sergey BOLDYREV, Soderkulla (FI); Jarmo ARPONEN, Espoo (FI); Jari-Jukka Harald Kaaja, Jarvenpaa (FI); Ian OLIVER, Soderkulla (FI); Mikko HAIKONEN, Espoo (FI); Saku SULANDER, Espoo (FI); Joni JANTUNEN, Helsinki (FI)

(73) Assignee: Nokia Corporation, Espoo (FI)

(21) Appl. No.: 12/696,873

(22) Filed: Jan. 29, 2010

(51) Int. Cl. H04Q 5/22

(52) U.S. Cl. 340/10.51

(57) ABSTRACT

An approach is presented for efficiently managing content, configuration and credentials among devices. A determination of information and related metadata associated with one or more devices available in an information space is made, wherein the information includes content, configuration, credentials, or a combination thereof of the one or more devices. The determined information and related metadata are aggregated and stored in a memory tag.

### BACKGROUND

Communication devices (e.g., mobile devices, computers, Internet tablets, etc.) with various methods of connectivity are now for many people becoming the primary gateway to the internet and also a major storage point for personal information. As part of this trend, service providers and device manufacturers are combining and providing interoperability among these myriad information processing devices, applications, and services. More specifically, one area of development has been the processing of information through numerous, individual and personal spaces in which persons, groups of persons, etc. can place, share, interact and manipulate webs of information with their own locally agreed semantics without necessarily conforming to an unobtainable, global whole. These information spaces, often referred to as smart spaces, are projections of the ‘Giant Global Graph’ in which one can apply semantics and reasoning at a local level. For example, a user of a device can download content (e.g. music, video) and subscribe to various services which can then become part of an information space associated with the user and/or device.

At the same time, it is noted that a user may often use many devices at the same time or switch from one primary device to another. For example, with rapid improvements in technology, new devices which support new technologies and applications may entice the user to change devices. One such technology in these new devices, for example, involves use of low-cost radio frequency (RF) memory tags (e.g., high memory capacity near field communication (NFC) tags or other wireless memory tags) that can be associated with user devices to facilitate access or transfer of digital content (e.g., applications, services, etc.). However, once these applications, services, and related configuration and preference information are configured for use on a particular device, the user may be reluctant to repeat the lengthy process of content transfer and configuration for a new communication device. Therefore, service providers and device manufacturers face significant technical challenges to enable users to migrate (e.g., backup, synchronize, copy, etc.) information including, e.g., content, configuration, settings, applications, etc. from one device to another. More specifically, the technical challenges relate, at least in part, to integrating the use of, for instance, RF memory tags within information spaces associated with devices engaged in such information migration operations.

### SOME EXAMPLE EMBODIMENTS

Therefore, there is a need for an approach for efficiently managing content, configuration and credentials among devices using RF or other wireless memory tags (hereinafter referred to as memory tags).

According to one embodiment, a method comprises determining information and related metadata associated with one or more devices available in an information space, wherein the information includes content, configuration, credentials, or a combination thereof of the one or more devices. The method also comprises causing, at least in part, aggregation of the determined information and related metadata. The method further comprises causing, at least in part, storage of the aggregated information and related metadata in a memory tag.

According to another embodiment, an apparatus comprising at least one processor, and at least one memory including computer program code, the at least one memory and the computer program code configured to, with the at least one processor, cause, at least in part, the apparatus to determine information and related metadata associated with one or more devices available in an information space, wherein the information includes content, configuration, credentials, or a combination thereof of the one or more devices. The apparatus is also caused to cause, at least in part, aggregation of the determined information and related metadata. The apparatus is further caused to cause, at least in part, storage of the aggregated information and related metadata in a memory tag.

According to another embodiment, a computer-readable storage medium carrying one or more sequences of one or more instructions which, when executed by one or more processors, cause, at least in part, an apparatus to determine information and related metadata associated with one or more devices available in an information space, wherein the information includes content, configuration, credentials, or a combination thereof of the one or more devices. The apparatus is also caused to cause, at least in part, aggregation of the determined information and related metadata. The apparatus is further caused to cause, at least in part, storage of the aggregated information and related metadata in a memory tag.

According to yet another embodiment, an apparatus comprises means for determining information and related metadata associated with one or more devices available in an information space, wherein the information includes content, configuration, credentials, or a combination thereof of the one or more devices. The apparatus also comprises means for causing, at least in part, aggregation of the determined information and related metadata. The apparatus further comprises means for causing, at least in part, storage of the aggregated information and related metadata in a memory tag.

According to one embodiment, a method comprises causing, at least in part, reading of information and related metadata from a memory tag, wherein the information includes content, configuration, credentials, or a combination thereof aggregated from an information space associated with one or more devices. The method also comprises causing, at least in part, extraction of the content, configuration, or credentials from the information and related metadata. The method further comprises causing, at least in part, reconstitution of the extracted content, configuration, and credentials in the information space or another information space associated with one or more other devices, wherein the reconstitution is based at least in part on capabilities of the one or more other devices, the credentials, or a combination thereof.

According to another embodiment, an apparatus comprising at least one processor, and at least one memory including computer program code, the at least one memory and the computer program code configured to, with the at least one processor, cause, at least in part, the apparatus to cause, at least in part, reading of information and related metadata from a memory tag, wherein the information includes content, configuration, credentials, or a combination thereof aggregated from an information space associated with one or more devices. The apparatus is also caused to cause, at least in part, extraction of the content, configuration, or credentials from the information and related metadata. The apparatus is further caused to cause, at least in part, reconstitution of the extracted content, configuration, and credentials in the information space or another information space associated with one or more other devices, wherein the reconstitution is based at least in part on capabilities of the one or more other devices, the credentials, or a combination thereof.

According to another embodiment, a computer-readable storage medium carrying one or more sequences of one or more instructions which, when executed by one or more processors, cause, at least in part, an apparatus to cause, at least in part, reading of information and related metadata from a memory tag, wherein the information includes content, configuration, credentials, or a combination thereof aggregated from an information space associated with one or more devices. The apparatus is also caused to cause, at least in part, extraction of the content, configuration, or credentials from the information and related metadata. The apparatus is further caused to cause, at least in part, reconstitution of the extracted content, configuration, and credentials in the information space or another information space associated with one or more other devices, wherein the reconstitution is based at least in part on capabilities of the one or more other devices, the credentials, or a combination thereof.

According to yet another embodiment, an apparatus comprises means for causing, at least in part, reading of information and related metadata from a memory tag, wherein the information includes content, configuration, credentials, or a combination thereof aggregated from an information space associated with one or more devices. The apparatus also comprises means for causing, at least in part, extraction of the content, configuration, or credentials from the information and related metadata. The apparatus further comprises means for causing, at least in part, reconstitution of the extracted content, configuration, and credentials in the information space or another information space associated with one or more other devices, wherein the reconstitution is based at least in part on capabilities of the one or more other devices, the credentials, or a combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of efficiently managing content, configuration and credentials among devices, according to one embodiment;

FIG. 2 is a diagram of the components of an information transferability manager, according to one embodiment;

FIG. 3 is a diagram of the components of a user equipment, according to one embodiment;

FIG. 4 is a flowchart of a process for efficiently managing content, configuration and credentials on a device, according to one embodiment;

FIG. 5 is a flowchart of an information aggregation and transfer process for efficiently managing content, configuration and credentials of a device, according to one embodiment;

FIG. 6 is a flowchart of a process for receiving transferable content, configuration and credentials by a new device, according to one embodiment;

FIG. 7 is a flowchart of an information extraction process from provided transferable content, configuration and credentials for a new device, according to one embodiment;

FIGS. 8A-8B illustrate utilization of information transfer among devices, according to various embodiments;

FIGS. 9A-9B illustrate utilization of an external storage for efficiently managing content, configuration and credentials among devices, according to various embodiments;

FIGS. 10A-10C illustrate utilization of information transfer among devices for backup and synchronization, according to various embodiments;

FIGS. 11A-11B illustrate tag based license management, according to various embodiments;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for efficiently managing content, configuration and credentials among devices are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term information space or smart space can be considered as an information set aggregated from a variety of different and distributed sources. The multi-sourcing of information gives an information space great flexibility and accounts for the fact that the same piece of information can come from different sources and different owners. Although various embodiments are described with respect to information spaces, it is contemplated that the approach described herein may be used with other distributed information sets.

As used herein, the term content, configuration and credentials refers to the information aggregated from one or more user devices for storage in an information space. Content refers to the data stored in the one or more devices such as media content (e.g., audio files, video files, multimedia files, etc.), document files, databases (e.g., personal information databases), etc. It is contemplated that content also includes application files (e.g., executable files), scripts, or other components related to services and functions of the device. Configuration refers to the setup or operational parameters of the one or more devices (e.g., preferences, wallpapers, ringtones, menu configuration, etc.) that identify user's preferred way of access or use the device and/or the content stored therein. Credentials refer to access rights and/or licenses for granting access to all or part of the content or configuration to a certain device such as passwords, client side persistency information, etc. Although various embodiments are described with respect to content, configuration and credentials, it is contemplated that the approach described herein may be used with other types of information associated with a user device.

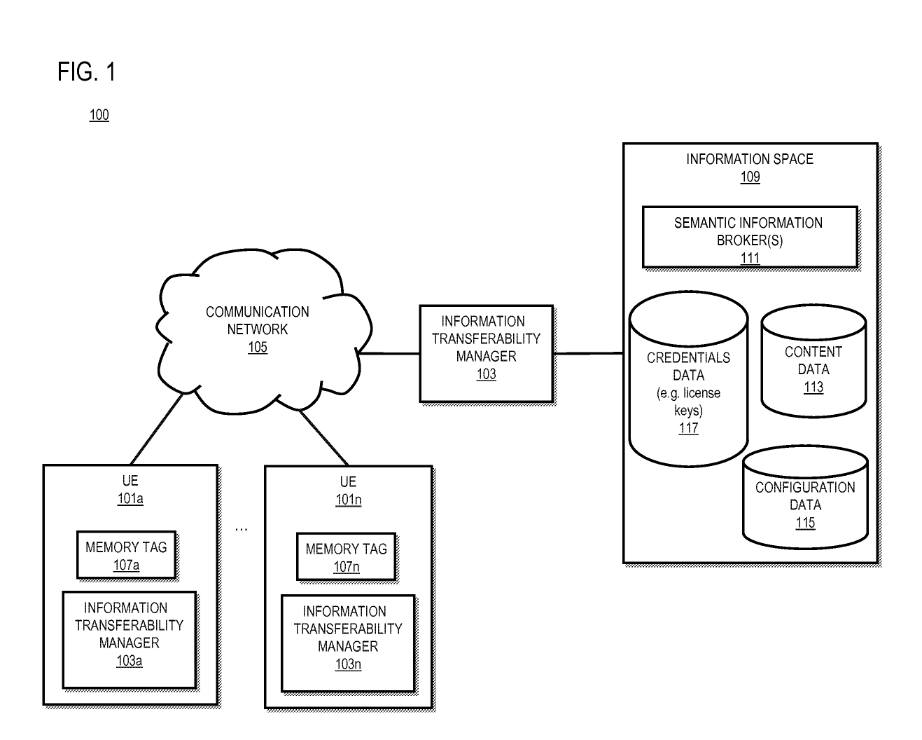

FIG. 1 is a diagram of a system capable of efficiently managing content, configuration and credentials among devices, according to one embodiment. Communication devices (e.g. mobile devices) are becoming one of the main tools for storing and accessing various kinds of information from favorite music to personal content. With recent developments in technology the capacity of the storage space available to the user of a device and the number and variety of available applications are increasing. Furthermore, the introduction of information spaces enable devices to connect to and access information that is distributed over a wide range of locations and platforms with different standards, thereby makes the process of managing such information among multiple devices quite challenging. As noted previously, modern devices offer a great deal of customizability which often results in the user spending a significant amount of time configuring user devices. Accordingly, users can be quite reluctant to repeat the setup and configurations for a new device (e.g., device new UE 101), even though the new UE 101 may offer more advanced services. This extra work becomes visible when the user obtains a new device to replace or be used alongside an existing device.

It is noted that in the course of normal use, a user device may accumulate various types of information (e.g., content, configuration, credentials). Because of the personal nature of how devices are typically used, the collected information is generally specific to a particular user and the different people, places, topics, applications, services, etc. the user interacts with. In one embodiment, the information may be available in the user's device or in the user's personal distributed information space. Furthermore, device users may sign up and buy, for example, access rights or licenses to download software or music to the device or information space. These credentials may be stored in the particular device obtaining the access rights or stored elsewhere in the information space and linked to the device. However, a user who upgrades a device may feel hesitant to recycle an old UE 101 out of concern about secure backup of the content, configurations and credentials from the old device and its related information space. The user may expect that, for example, the same music or other content that was purchased to be stored on the old UE 101 will be available on the new UE 101 without losing the license granted. In some cases, the user may also feel hesitant to obtain a new UE 101, unless there is a clear mechanism for transferring content, configuration, and credentials information to the new UE 101. Therefore, there is a need for an approach for easy and reliable transfer of content, configuration and credentials between devices.

In order to avoid loss of important data (e.g., device content, configuration, and credentials)when buying a new device and/or updating the firmware on the current device, a typical device user may have to perform multiple synchronizations and/or backups with no guarantee that the information backed up from one device will be usable on a new device. Otherwise, the user would have to manually reconfigure the new device and may need to research whether previous content, configurations, and credentials (e.g., media access rights) would be available and/or supported by the new purchased device. Therefore, methods for managing (e.g., backing up, synchronizing, etc.) the combined content, configuration and credentials between devices are needed. Furthermore, the heterogeneity of available information, providers of the information, and users of the information create significant technical challenges for managing and enforcing access rights to information contained in information spaces.

To address this problem, a system 100 of FIG. 1 introduces the capability to provide transferable content, configuration and credentials for managing such information among devices via radio frequency (RF) memory tags. By way of example, a user of a communication system generally has access to an assigned storage capacity defined in an information space, local mass-storage, external storage devices (e.g., portable memory sticks), or a combination thereof, where content is gradually transferred (e.g., backed up, synchronized, copied, replicated, etc.). In one embodiment, a distributed information gathering technology (e.g., an information space) can operate over these various storage locations and devices to determine the content, configuration, and credentials structure of a source device (e.g., an old phone) and then transfer this structure to target device (e.g., a new phone) in a form that is compatible with the target device. More specifically, such a structure can be aggregated from an information space associated with the old device and stored in an RF memory tag. The new device can then read structure from the memory and reconstitute the content, configuration, and credentials in either the same information space or a new information space associated with the new device. In one embodiment, the RF memory tag uses short range connectivity such as Ultra High Frequency/Near Field Communication (UHF/NFC) and/or Impulse based Ultra Wideband (I-UWB) for data transfer between the memory tags the either the writing device (e.g., the old device) or the reading device (e.g., the new device).

According to one embodiment, user context information including content, device configurations and credentials, is backed up from the memory or information space of a device. Metadata (further information about the data including data type, data format, data volume, data location, etc.) is added to the context information to describe how the information is used and stored in the devices. The combination of the context information and the metadata is then stored in a RF memory tag associated with the device. In one embodiment, the combined context information and metadata is stored as a binary data block. It is contemplated that the combination can be stored using any other memory format. The combined information is then transferred to, for instance, a passive embedded RF memory tag in the existing device, the target device, external device (e.g., an external backup storage or storage component of an information space). If the information is transferred to a new device, the information is unpacked from its stored form (e.g., the binary block) to be available in the smart space knowledge processors available in the new or target device.

As shown in FIG. 1, the system 100 comprises a user equipment (UEs) 101a-101n having connectivity to an information transferability manager 103 via a communication network 105. The information transferability manager 103 may act as an interface between one or more UEs 101 and one or more information spaces 109. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 101a-101n is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UEs 101a-101n can support any type of interface to the user (such as “wearable” circuitry, etc.). In one embodiment, each of the UEs 101a-101n may include a respective memory tag 107. In addition or alternatively, the memory tag 107 may be external to the UE 101 (e.g., connected via an external dongle device). By way of example, the memory tag 107 is a near field communication (NFC) tag, radio frequency identification (RFID) tag, contactless card, a wirelessly powered memory tag, or the like that includes sufficient memory to store information (e.g., content, configuration, and credentials) related to the respective UE 101. The memory tag 107, for instance, is associated (e.g. embedded in or attached to) one or more of the UEs 101 capable of supporting the information management processes of the approach described herein. In one embodiment, the memory tag 107 is a high memory capacity NFC tag that contains several gigabits of memory with fast access and download times. It is contemplated that the memory tag 107 may also be any similar wirelessly powered memory tag.

By way of example, NFC, RFID, contactless card, and similar technologies are short-range wireless communication technologies (e.g., Ultra High Frequency/Near Field Communication (UHF/NFC) and/or Impulse based Ultra Wideband (I-UWB)) that enable the exchange (e.g., both reading and writing) of data between devices and tags over short distances (e.g., the range for NFC is approximately 4 inches). In general, these technologies comprise two main components, a tag (e.g., attached to a UE 101) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials. Moreover, the tags may be passive tags or active tags. Passive tags are generally smaller, lighter, and less expensive than active tags. Passive tags are only activated when with the response range of a reader/writer. In other words, passive tags are typically memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the memory tag 107 can, for instance, enable the system 100 to write comments for storage in the memory tag 107 for retrieval by other users or update the content of the memory tag 107 to include the latest content. For example, a memory tag 107 associated an advertisement can be updated to contain the latest pricing and availability information.

A reader/writer typically contains a transmitter, receiver, control unit, and an antenna. The reader/writer performs several primary functions: energizing the tag, demodulating and decoding the returned radio signal, and providing clock information. In certain embodiments, a reader/writer includes an additional interface to convert the returned radio signal to a form that can be passed to another system such as a computer or programmable logic controller.

In one embodiment the UEs 101a-101n communicate with one or more information spaces 109, where user information for UEs is stored and processed, through an information transferability manager 103.

In yet another embodiment, the UEs 101a-101n may be equipped with an internal information manager 103 that has the capability of direct communication with the information space 109. The information transferability manager 103 may include one or more components for efficiently managing content, configuration and credentials among devices. Each information space 109 includes one or more semantic information brokers 111 which form the nucleus of the information space. A semantic information broker is an entity performing information governance in possible co-operation with other semantic information brokers for one information space. A semantic information broker may be a concrete or virtual entity. Each semantic information broker also supports the information space components (e.g., a user, a mobile terminal, or a PC) interacting with other semantic information brokers through information transaction operations.

An information space 109 includes various information types for each user. These information types are mainly, content data 113 which may include information such as contact lists, personal notes, favorite music, articles, applications, etc. The content may be related to people, places or various topics. The content may also refer to different applications and services available through the device. The configuration data 115 contains information regarding service configurations or device configurations for accessing and processing of the content data. The configuration may include certain mode or initialization for executables (e.g. applications), data storage and display formats, device setup, ringtones, wall papers, etc. The credentials data 117 contains license keys and access rights for device access to the content and services available on the information space that need authorization. It is noted that due to the distributed nature of information spaces, the information space 109 can be distributed over several devices in various locations. This means that each of the content data 113, the configuration data 115 and the credentials data 117 may also be of a distributed nature. For example, a document may be stored on one device while a user license for accessing the document may be on another device in another location which is still within the information space environment. It is also possible that the document is stored in a distributed manner and not in one location. For example, an information space may contain a digital copy of a book, while chapters of the book are stored on a distributed basis over the devices within the scope of the information space 109. In such a case, configuration information can be defined and used for managing the information distribution. Furthermore, metadata such as size and storage location of data files can be utilized for keeping track of the distributed parts of information and create links between the parts.

In one embodiment, if the content, configuration and credentials related to one or more executable modules are being transferred from one device information space to another device information space where the modules are incompatible with the acceptable format in the new UE 101, the information space knowledge processors will wrap the newly received data with an adaptation wrapper to enable the execution in the new device runtime environment. The wrapping process may include instruction level virtualization, translation of the one or more incompatible portions, or a combination thereof. Because of the distributed nature of information spaces, knowledge processors that process the information can be located in the UE 101 or as separate equipment or components having connectivity to the UE 101 and the information space 109 via the communication network 105. The wrapping or adaptation process may be conducted by the knowledge processors from either the information space 109 or UEs 101. It is noted that the devices (e.g., the existing and target devices) may share the same information space 109 and the adaptation wrapping may be conducted within the same information space 109 environment.

In another embodiment, if enforcement of specific security policies on the transferred data is necessary, any of the various access management approaches for information spaces such as digital signatures or more specifically license distribution can be applied. Digital signatures are used to implement electronic signatures in order to demonstrate the authenticity of a message or document or access rights to the information. Digital signatures are created by application of cryptography techniques on pieces or information or their combination. Another security policy used for preventing unauthorized access to information and services is license distribution. A license may be in the form of freeware, shareware or come with a newly purchased (e.g. downloaded) service. Other security policies or access management technologies including digital rights management (DRM) policies for accessing media may be used.

By way of example, the UE 101, information transferability manager 103 and the information space 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

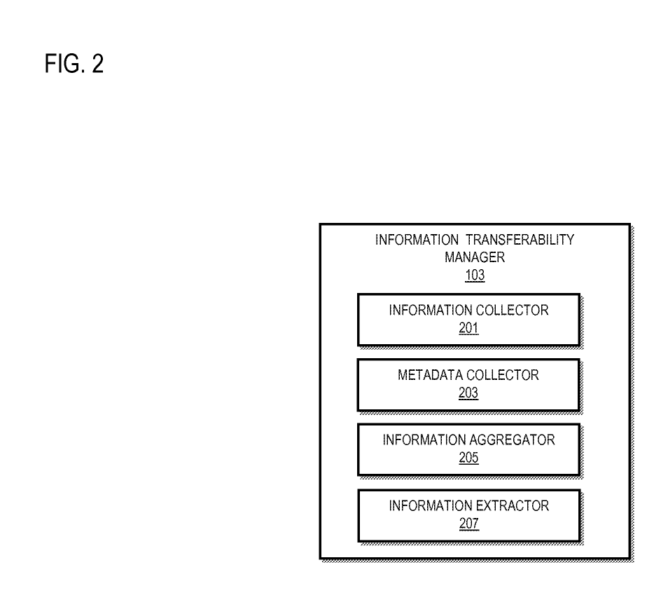

FIG. 2 is a diagram of the components of information transferability manager 103, according to one embodiment. By way of example, the information transferability manager 103 includes one or more components for efficiently managing content, configuration and credentials among devices. It is contemplated that the functions of these components may be combined in one or more components or performed by other components of equivalent functionality. In this embodiment, the information transferability manager 103 includes an information collector 201, metadata collector 203, an information aggregator 205 and an information extractor 207.

In one embodiment, the information transferability manager 103 receives a request for information management (e.g., backup, synchronization, etc.) for one or more users from one or more UEs 101a-101n or other devices connected to the communication network 105 and existing within the same information space 109. Upon receiving the request, the information transferability manager 103 activates the information collector 201. The information collector retrieves the information related to one or more requesting UEs from the content data 113, the configuration data 115 and the credentials data 117. The information collector 113 may use various search techniques or query strategies to locate the requested content within the information space 109. Once the content is collected, the related configuration data 115 can be located and collected. For example, the location of the data 115 may be within any node of the information space 109 (e.g., the UE 101, or other component of the information space 109). The credentials data 117 that include access rights for devices to the contents may act as links between the content 113 and the devices (e.g., requesting device and target device). The information collector 201 may search the credentials data 117 for any credentials related to the requesting device for access to the requested content and collect the results found.

Furthermore, the metadata collector 203 retrieves metadata related to the collected information (content, configuration and credentials) from the information space 109. The metadata may include information specifications such as location, format, type, size, etc, and may be extracted from storage devices. The metadata can be later used for creating links between distributed pieces of information. The metadata can also be used for optimized distribution of the collected information during information management operations (e.g., backup, restoration, or synchronization processes). Following the information and metadata collection the information aggregator 205 combines the collected information and metadata. The information aggregator 205 stores the aggregated information in memory tag 107a-107n. If the purpose of aggregation request is creating a backup from the information, the aggregated information is stored in the media that has been provided for backup. Otherwise, if the aggregation request has been submitted for synchronization among two or more UEs 101a-101n, the information transferability manager 103 alerts the target or destination UE 101 to read the aggregated information from memory tag 107 of the origin UE. The destination UE 101 reads and stores the information in the memory tag 107 of the destination UE 101.

Once the aggregated information is transferred, the destination UE 101 alerts the information transferability manager 103 of the transfer completion; upon receiving the alert the information transferability manager 103 activates the information extractor 207. The information extractor 207 extracts components such as metadata, content information, configuration information and credentials information from the aggregated information in the memory tag 107 of the destination UE 101 and stores the extracted information in the memory of the destination UE 101. The information transferability manager 103 transfers the extracted components to their designated storage areas in the information space 109 related to the destination UE 101. In one embodiment, the designated storage areas are defined in the metadata associated with the transferred information.

In some embodiments, following transfer of the information to the destination UE 101, the information transferability manager 103 may initiate operations to delete or otherwise remove the aggregated information from the old or source UE 101. Additionally, as part of the delete operation, the information transferability manager 103 may also take a “snapshot” of the aggregated information for storage and retrieval as backup images.

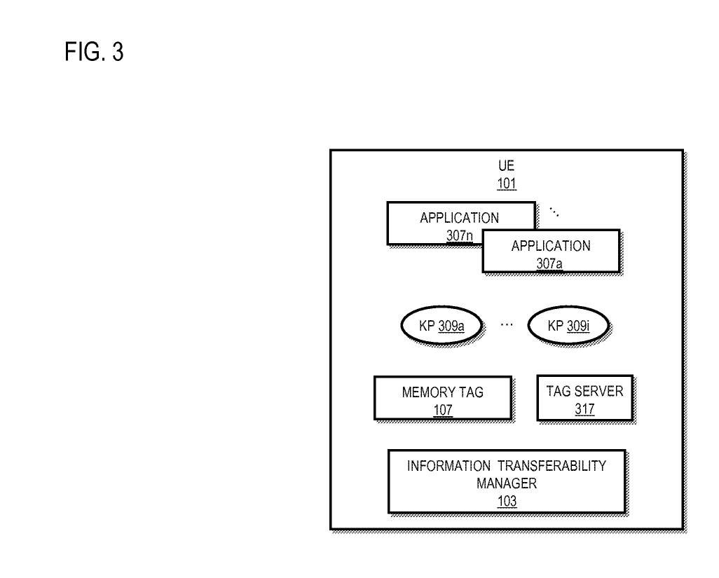

FIG. 3 is a diagram of the components of a user equipment, according to one embodiment. Every UE 101 contains applications 307a-307n that are software services provided by the UE to the user such as contact list manager, tools (e.g., calculator, alarm clock, etc.), music organizer/player, photo albums, email reader, text messenger, etc. The applications may be applied on the data stored locally in the permanent memory (not shown) of the UE 101, in a memory tag 107 or in an external location as part of an information space 109 accessible by the UE 101 through the communication network 105. Typically, when a user intends to synchronize information between an old UE 101 and a new UE 101, the new UE 101 is equipped with more advanced and/or different technologies (e.g., processors, memory, built-in sensors, components, etc.) than the old UE 101. For example, the incorporation of new technologies or services may be the motivator for the user to purchase or obtain a new UE 101. Therefore, normally the applications on the new UE 101 may be different or incompatible with the applications on the old UE 101. However, this is not always the case. For example, a user may replace a damaged UE 101 with another UE 101 with exact same specifications. The user may even opt for an older or simpler version of the UE 101 with more limited services for various reasons such as service cost.

The knowledge processors KP 309a-309i are components that process the user data with regards to an information space 109 that the UE 101 has connectivity to. A knowledge processor 309 may be located in various locations throughout the information space 109 environment, including the UE 101. The above mentioned point regarding the existence of extra applications in a new UE 101 can be extended to the knowledge processors 309 as well. For example, a new UE 101 with extra (or more advanced) applications 307 compared to an old UE 101 may be equipped with extra knowledge processors 309 for conducting processes that may have not been a part of the old UE 101 services. Therefore, the new UE 101 can be equipped with a larger number or a different combination of knowledge processors 309 or the knowledge processors 309 that conduct processes in the new UE 101 similar to the processes or the old UE 101 may be more advanced and optimized compared to their counterparts in the old UE 101.

In one embodiment, the memory tag 107 can be an internal component of the UE 101 (e.g., an embedded tag) or an external storage device and/or knowledge processor 309 connected to the UE 101. The tag server 317 manages the access to memory tag 107 and operations such as reading, writing and organizing of information on the memory tag 107.

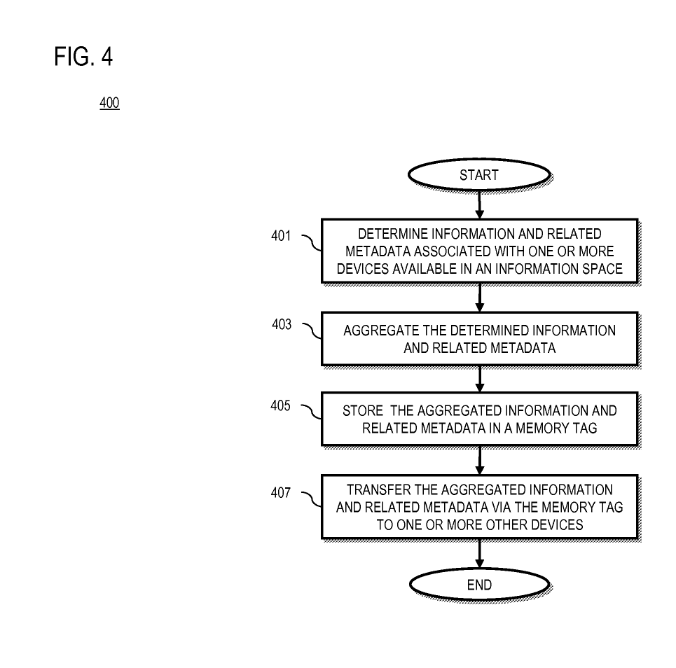

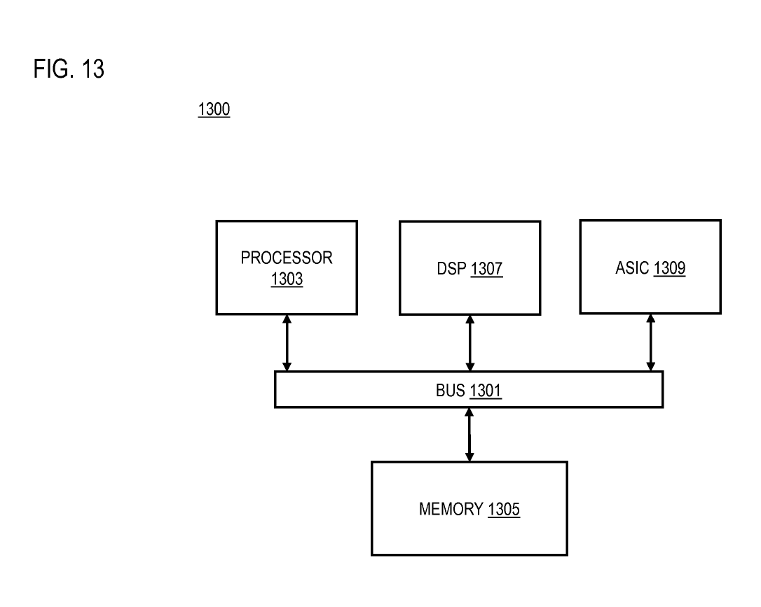

FIG. 4 is a flowchart of a process for efficiently managing content, configuration and credentials on a device, according to one embodiment. In one embodiment, the information transferability manager 103 performs the process 400 and is implemented in, for instance, a chip set including a processor and a memory as shown in FIG. 13. In step 401 the information transferability manager 103 determines the information and the related metadata associated with one or more UE 101 available in an information space 109. The information may include content of user data such as audio, video, text files, images, applications, etc.; configuration data that is used for setup and tailoring the content to be accessed and used by a UE; and credentials that determine access rights and information privacy and security. Metadata, which is data about data, describes the determined information. The metadata may include data structures, file indexes, data location, size, format, etc. Metadata can be retrieved from media management systems or content providers (not shown) that manage or provide the data (e.g., music stores or portals). The information collector 201 collects the information and the metadata collector 203 collects the related metadata from storage media associated with the information space 109. The collected data may be first stored in a local memory inside the UE 101, in a passive external memory or in a distributed memory on the information space 109 associated with the UE 101.

Following the collection and storage of the information and the metadata, the information transferability manager 103 signals the information aggregator 205 that the information is ready for aggregation. The signal may include information needed to accessing the collected information and the metadata. In step 403, the information aggregator 205 retrieves the collected information and metadata and combines the collected information and the metadata. The information aggregator 205 may encode the information for example by binding them together with configuration binary blocks. The information aggregator 205 may also use algorithms to analyze the information and group them based on their structure, format, type, etc. The information aggregator may also use data compression methods in order to reduce the volume of the aggregated information. The compressed information can be stored and/or transferred in a shorter time and can save memory space. In step 405, the information aggregator 205 stores the aggregated information in a memory tag 107. The memory tag 107 may be attached to the UE or accessed by the UE through any short range radio or wireless transfer protocol. In step 407, the information transferability manager 103 transfers the aggregated information either to a new UE 101 (e.g., in order to synchronize the new UE 101 with the old UE 101), a storage device (e.g., as a backup), or other component of the information space 109 (e.g., for synchronization). As noted previously, in certain embodiments, the transferred information may be deleted from the old UE 101, and the old UE 101 is returned to a blank state to limit potential exposure of the information.

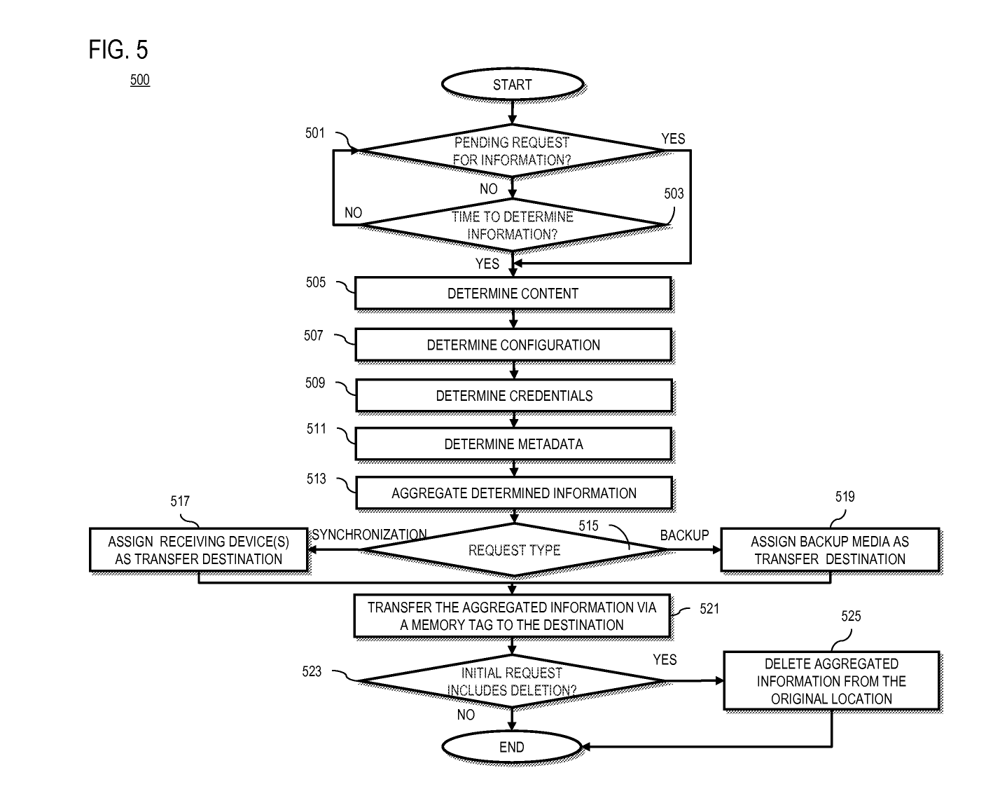

FIG. 5 is a flowchart of an information aggregation and transfer process for efficiently managing content, configuration and credentials of a device, according to one embodiment. In step 501, the information transferability manager 103 checks whether there is a pending request from a UE 101 for information transfer. In step 503, the information transferability manager 103 checks whether it is time to perform a scheduled backup, transfer, synchronization, or the information management operation. If there is a pending or scheduled request, as per step 505, the information transferability manager 103 activates the information collector 201 to collect the content information associated to the UE 101. For example, the content information is the information that a user collects while using a UE 101. The UE 101 may also automatically collect this content as part of its normal operation. The content information can be linked to different people, places, topics, applications, services, etc.

The content information is configured and stored in the memory of the UE 101 or in a distributed information space 109 associated with the UE 101. The configuration information may include service levels, display options, sounds, messages and similar setup options selected by the user on a UE 101. In step 507, the information collector 203 determines the configuration information associated with the collected content information.

A user of the UE 101 may also obtain access rights to services by, for instance, subscription or purchasing a certain license. For example, a user may download music from a pay per download website. In such cases, the user may create an account or receive an access code or password for accessing the subscribed services. The information associated with user's access rights (or credentials) may be stored in the UE 101 memory and/or in the associated information space 109. In step 509, the information collector 203 determines the credentials that have been set for the UE access rights.

In step 511, the information aggregator 205 aggregates the information collected from steps 505 to step 511. The aggregation enables the information transferability manager 103 to transfer the information with one transfer process. It also makes information compression possible which in turn will save space and transfer time. The intermediate information collected in steps 505 to 511 may be stored in local memory, memory tag 107, a memory space on the server hosting the information space 109 associated with the UE, or a combination thereof.

In step 515, the information transferability manager 103 initiates the transfer process based on the initial request. If there is a request from a user for synchronization between the old UE 101 with a new UE 101, per step 517, the information transferability manager 103 designates the one or more new UEs 101 as the transfer destination. Otherwise, if the user requested a backup or the scheduler indicates that it is time for a routine backup, per step 519, the information transferability manager 103 designates the backup media identified by the user or pre-assigned for routine backups as the transfer destination. The backup media may be a memory tag 107 (e.g., removable or embedded), compact backup storage media, a memory space on the server hosting the information space 109 associated with the UE, and the like. Once the transfer destination is designated, per step 521, the information transferability manager 103 transfers the aggregated information to the designated destination media.

In one embodiment, the device or user that requested the information in step 501 may also request deletion of the aggregated information from the memory tag 107, the old UE 101, the information space 109, etc. after the transfer is complete. For example, a user may want to recycle an old UE 101 after aggregating and transferring its content to a new UE 101. However, the user may be reluctant to recycle the old UE 101 if personal information remains in the memory of the UE 101. In step 523, the information transferability manager 103 checks whether the initial request includes a request for deletion of information after transfer. If a deletion request exists, as per step 525, the information transferability manager 103 removes the original information used for aggregation from the original location, the memory tag 107, the information space 109, etc. Since duplicate copes of the same information may exist in more than one location throughout the information space 109, the deletion request may include an option for deleting all or some of the occurrences of the information.

In one embodiment the process of synchronization or backup may be performed periodically. For such periodic processing, an internal timer can be set. In this case, the process of FIG. 5 can be executed in a loop so that the step 501 continuously checks for any new requests and step 503 checks the timer for the periodic process.

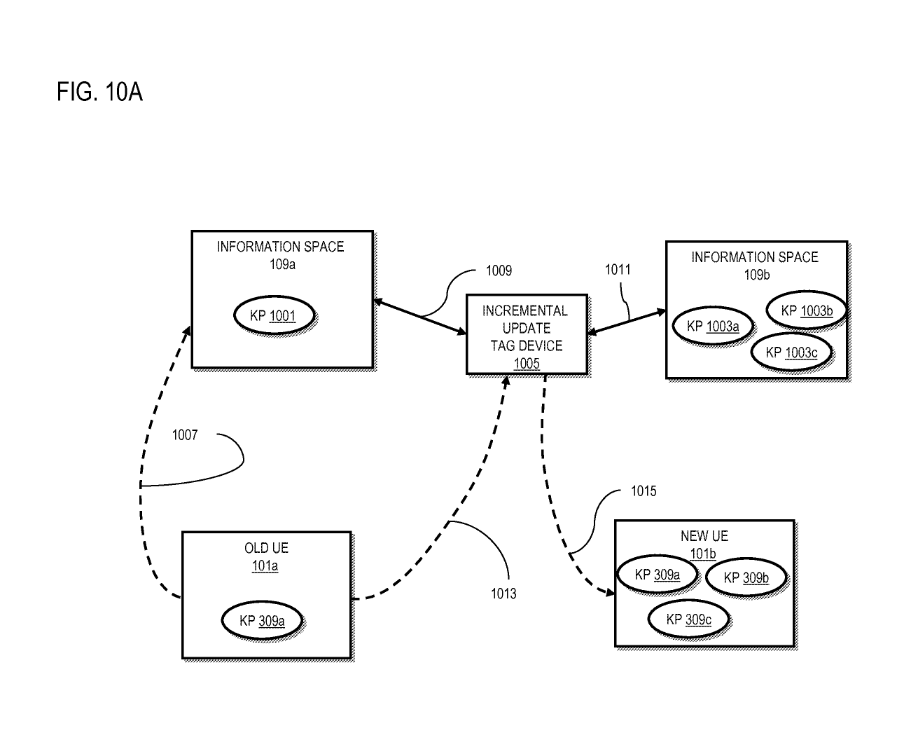

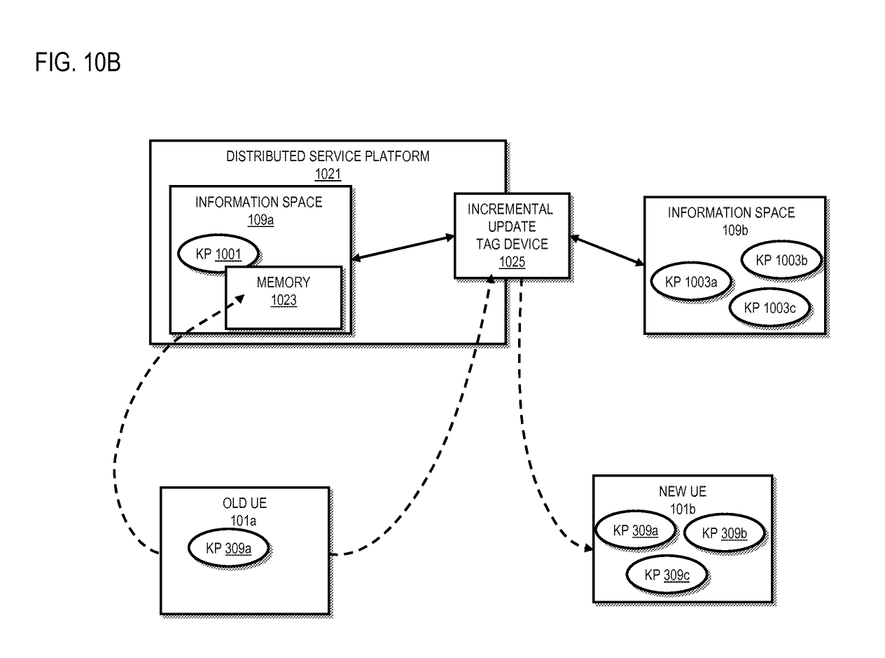

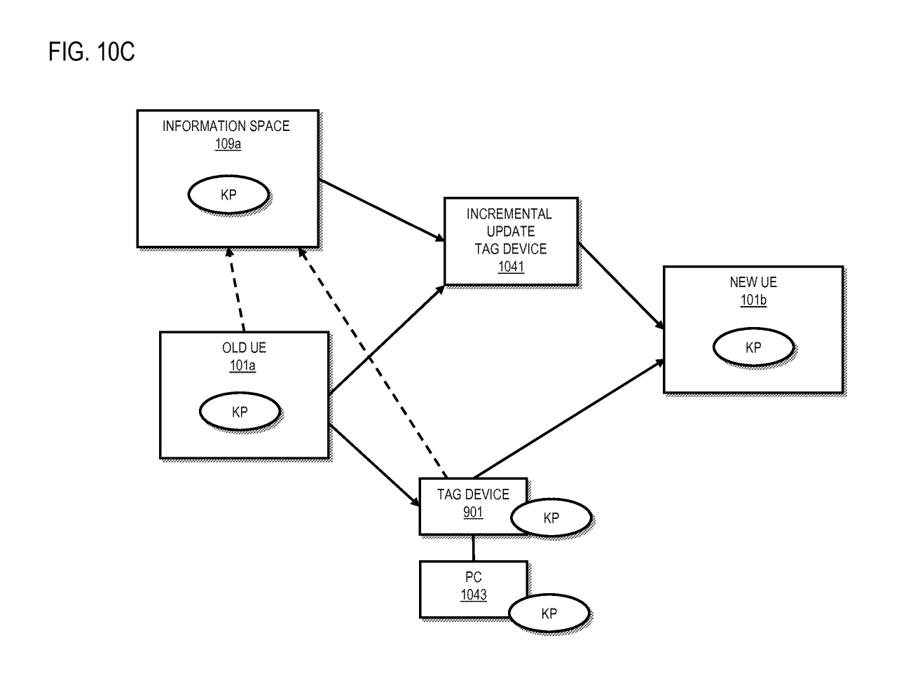

In another embodiment, the process of synchronization or backup may be performed incrementally. In this embodiment, a component of the information space 109 (e.g., a knowledge processor 309, SIB 111, etc.) may periodically compare the information in the UE 101 with the information in a related information space 109. If there are local changes at the UE 101 that have not been reflected in the content of the information space 109, the component may update the information if it is feasible. The component may also incrementally update the information in a new UE 101 using the information from an old UE 101 and (or) the related information space 109. The incremental backup and synchronization process is further discussed in FIGS. 10A-10C

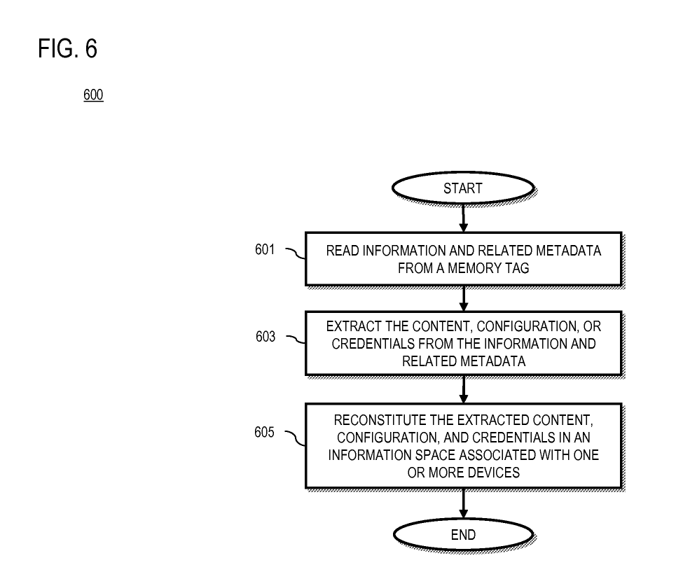

FIG. 6 is a flowchart of a process for receiving transferable content, configuration and credentials by a new device, according to one embodiment. In step 407 of FIG. 4 and step 521 of FIG. 5, the aggregated information and metadata are transferred to one or more devices by the information transferability manager 103. If the new UE 101 is a storage media, the aggregated information is stored for future use. Otherwise, if the new UE 101 is a device that needs to be synchronized based on the received information, the process of FIG. 6 is performed. In step 601, the information transferability manager 103 of the new UE 101 reads the received aggregated information and metadata from the memory tag 107. For example, the read information may be stored in a local memory, in an external memory, in the information space 109, or any other type of storage media. In step 603, the information extractor 207 extracts the metadata, the content, the configuration and the credential information from the received aggregated information and stores the extracted information. The extraction procedure may include parameters, information, guidance, etc. for decoding and decompression of the information. In step 605, the information transferability manager 103 reconstitutes the extracted information and stores them in the memory space designated to one or more information spaces 109 associated with the new UE(s) 101. The reconstitution may include initialization of configurations for variables, links and applications, installing the applications, populating the databases with the transferred content, re-establishing the credentials such as saved passwords, cookies, etc., refreshing and tailoring the metadata and storing the metadata in the new UE(s) 101 storage media. In one embodiment, if one or more applications or parts of the applications are not compatible with the new UE(s) 101 configurations, the reconstitution process may include adapting the incompatible application(s) to the new UE(s) 101. By way of example, as described previously, the adaptation is performed by using adaptation wrappers provided by the information transferability manager 103 either of the new UE(s) 101, the old UE 101, or both.

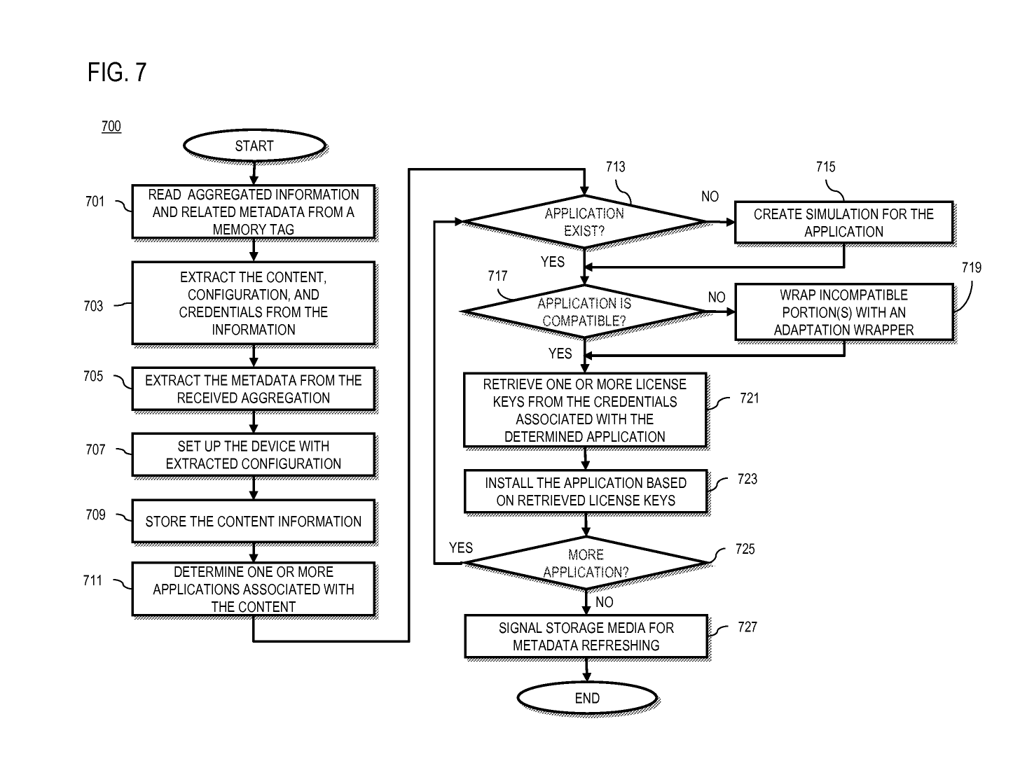

FIG. 7 is a flowchart of an information extraction process from provided transferable content, configuration and credentials for a new device, according to one embodiment. In step 701, the information transferability manager 103 of the new UE 101 reads the received aggregated information and metadata from the memory tag 107. The read information may be stored in a local memory, in an external memory, in the information space 109, or any other type of storage media. In step 703, the information extractor 207 extracts the content, the configuration and the credential information from the received aggregated information and stores the extracted information. The extraction procedure may include decoding and decompression of the information. In step 705, the information extractor 207 extracts the metadata from the received aggregated information and stores the extracted metadata. In step 707, the information transferability manager 103 applies the extracted configuration information to those services and applications provided by the new UE 101 that are equivalent with services and applications on the old UE 101. These configurations may include initialization of variables, parameters, links and applications. In step 709, the information transferability manager 103 populates the databases associated with the new UE(s) 101 with the transferred content. The content information may for example include address book information, audio files, notes, videos, applications, etc. In step 711, the information transferability manager 103 of the new UE 101 determines the applications in the new UE 101 that are associated with the content. The applications available on the new UE 101 may be different from the applications available on the old UE 101. In one embodiment, the new UE 101 may not be equipped with any applications equivalent to an application from the old UE 101. As per step 713, if an application is not found, in step 715, the information transferability manager 103 simulates the application in the environment of the new UE 101. The simulation process may include creating a duplicate of the application in the new UE 101 and tailor it to the configuration of the new UE 101 using available software tools and scripts (e.g., adaptation wrappers).

In some embodiments, several different compatibility situations may arise between applications on the old and the new UEs 101. In one embodiment, the same version of an application on the old UE 101 may exist on the new UE 101. In such a case, the two applications are considered compatible. In another embodiment, a different version of the application on the old UE 101 may exist on the new UE 101. In this case, the two applications may be incompatible. In step 717, the information transferability manager 103 checks the compatibility and if two applications providing similar services are incompatible, in step 719, the information transferability manager 103 uses an adaptation wrapper on the application in the new UE 101 to make it compatible with the application on the old UE 101. The adaptation may be performed by the information transferability manager 103 either of the new UE(s) 101, the old UE 101, or both.

In one embodiment, a situation may arise where one or more applications exist on the old UE 101 but do not have any similar counterpart applications on the other device that provide the same services. In such situation, the information transferability manager 103 may prompt the user and seek user approval to download and install the same or more recent versions of the applications or the user may choose to download the applications manually.

In another embodiment, one or more new applications may exist on the new UE 101 providing services not available on the old UE 101. In this case, the information transferability manager 103 may produce a report for the user, listing the new available applications and allowing the user to select their own application or version.

In step 721, the information transferability manager 103 retrieves old UE 101 credentials such as saved passwords, cookies, license keys, etc., associated with the application and services from the extracted information. In step 723, the information transferability manager 103 installs and initializes the application using the credentials where applies. If there are more applications to be installed the step 725 leads back to step 713 and the installation and initialization process is repeated for all the available applications until there is no application left. In step 727, the information transferability manager 103 sends the extracted metadata to the media manager or content provider (e.g., database management system) for the metadata for the newly stored data to be refreshed accordingly.

In one embodiment, when a new UE 101 is being given access to the content, configuration and credentials associated to an old UE 101, the information transferability manager 103 may only transfer the information that locally exist on the old UE 101 and for the information that are already stored in the information space the information transferability manager 103 may collect links to the locations where the information and metadata are stored. These links can then be transferred to the new UE 101 so that the UE 101 can gain access to the information using the links. In this embodiment, the new UE 101 will gain connectivity to the same information space 109 associated to the old information space 109. In order to prevent information inconsistency in the shared information space 109, various information sharing technologies may be used.

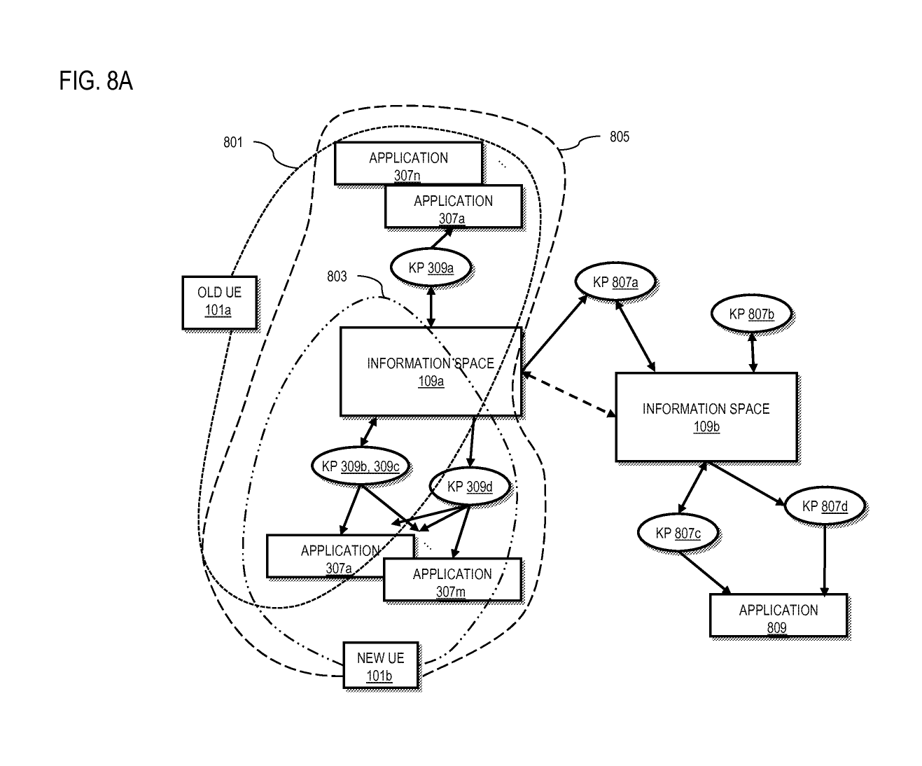

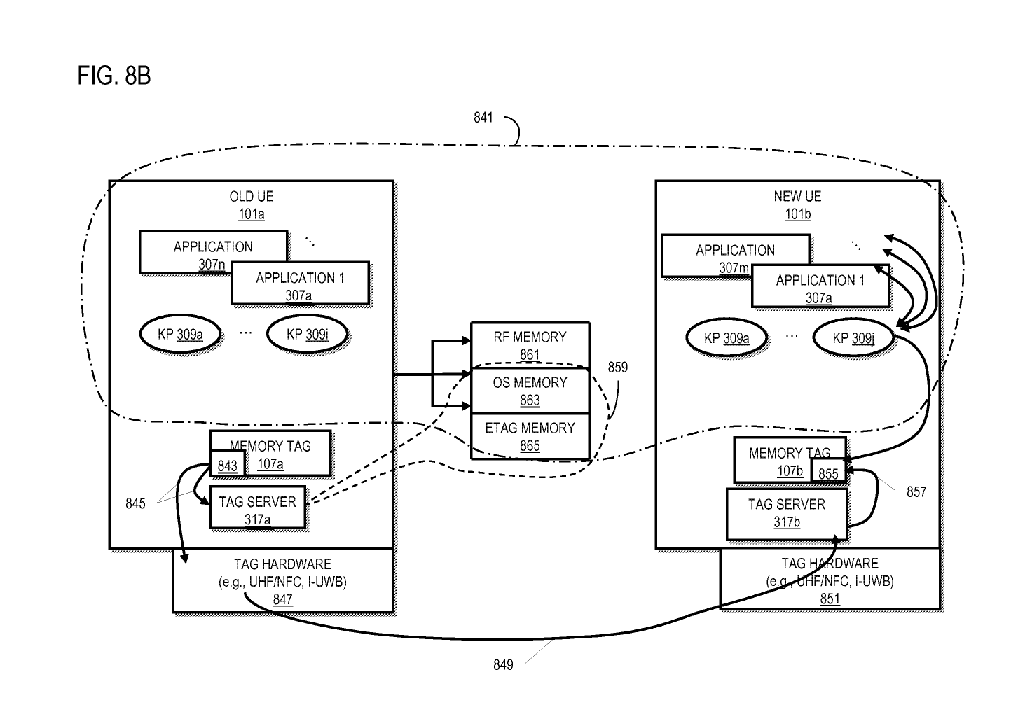

FIGS. 8A-8B illustrate utilization of information transfer among devices, according to various embodiments. The area of FIG. 8A marked with dotted line 801 encircles the components associated with the old UE 101a. The information space 109a is the information space used by the old UE 101a. The knowledge processors KP 309a-KP 309d are components that process the information of the information space 109a with regards to the old UE 101a requests. The UE 101a may have internal knowledge processors 309; have connectivity with external knowledge processors 309 through the communication network 105; receive service by the knowledge processors 309 within the information space 109 environment; or a combination thereof. Applications 307a-307n are applications that UE 101a has access to for retrieving information from the information space 109a. As seen in FIG. 8A, the knowledge processor KP309a connects applications 307a-307n to the information space 109a.

The area of FIG. 8A marked with dotted line 803 encircles the components associated with the new UE 101b before the content, configuration and credentials are transferred from the old UE 101a to the new UE 101b. The information space 109a is also the information space used by the new UE 101b, however, the new UE 101b may have access to a part of the information space 109a different from the part that the old UE 101a has access to. The knowledge processors KP 309b, KP 309c and KP309d are components that process the information of the information space 109a with regards to the new UE 101b requests. It is noted that one or more UEs 101 may have connectivity to one or more shared knowledge processors 309. As seen in FIG. 8A, the knowledge processors KP 309b and KP 309c are used by both the old UE 101a and the new UE 101b. Applications 307a-307m are applications that the new UE 101b has access to for retrieving and handling information from the information space 109a. As seen in FIG. 8A, the knowledge processor KP 309b, KP 309c and KP 309d may serve one or more of the applications 307a-307m to the information space 109a.

The area of FIG. 8A marked with dotted line 805 encircles the components associated with the new UE 101b following the transfer of content, configuration and credentials from the old UE 101a to the new UE 101b. As seen, the area 805 covers all the content, configuration and credentials from the old UE 101a in addition to the new enhancements and additions available in the new UE 101b.

In FIG. 8B, the encircled area with dotted line 841 shows part of the information space environment within the old UE 101a and new UE 101b. The aggregated information composed of device configuration, content and credentials produced by the information transferability manager 103 may be stored in portion 843 of memory tag 107a of the old UE 101a. The metadata related to the context information is added to the information and the aggregated information is stored in memory 843. The UEs 101 may include various areas of address spaces including the RF memory 861, the Operating System memory 863 and the embedded tag (Etag) memory 865. The information transferability manager 103 notifies (shown by arrows 845) the tag server 317a and the tag hardware 847 of the stored user context information in memory 843. The tag hardware can be any short range radio or wireless transfer protocol such as Ultra High Frequency/Near Field Communication (UHF/NFC) and/or Impulse based Ultra Wideband (I-UWB).

The information transferability manager 103 transfers the stored aggregated information in memory 843 to the new UE 101b. The transfer, shown by arrow 849, takes place from the memory tag 107a to the memory tag 107b through the tag hardware 847 and 851 and tag servers 317a and 317b. The received information is stored in memory tag 107b (portion 855) of the new UE 101b. In aggregated information may then be transferred from the memory tag 107b to the new UE 101b's main memory (not shown). Following the transfer, the information transferability manager 103 may compile list of the available information, extract the information for content, configuration and credentials and store the extracted information in related locations of the information space 109.

For the information to be processed in the new UE 101b, knowledge processors 309 are used. Knowledge Processors KP 309a-KP 309j are entities that constitute the applications, common for old and new UEs 101. The new UE 101b may have new knowledge processors 309 specific to the new UE 101b constituting new applications that did not exist in the old UE 101a. The applications may be installed on the new UE 101b by their specific knowledge processors 309, alternatively the new UE 101b may request a process through the same knowledge processors that were handling applications in the old UE 101a, or the applications can be processed through a different (a new) knowledge processor in the new UE 101b. Certain applications may or may not be supported by the new UE 101b. As seen in FIG. 7, in such cases the information transferability manager 103 can either simulate/emulate a non-existent application or use an adaptation wrapper on an incompatible application.

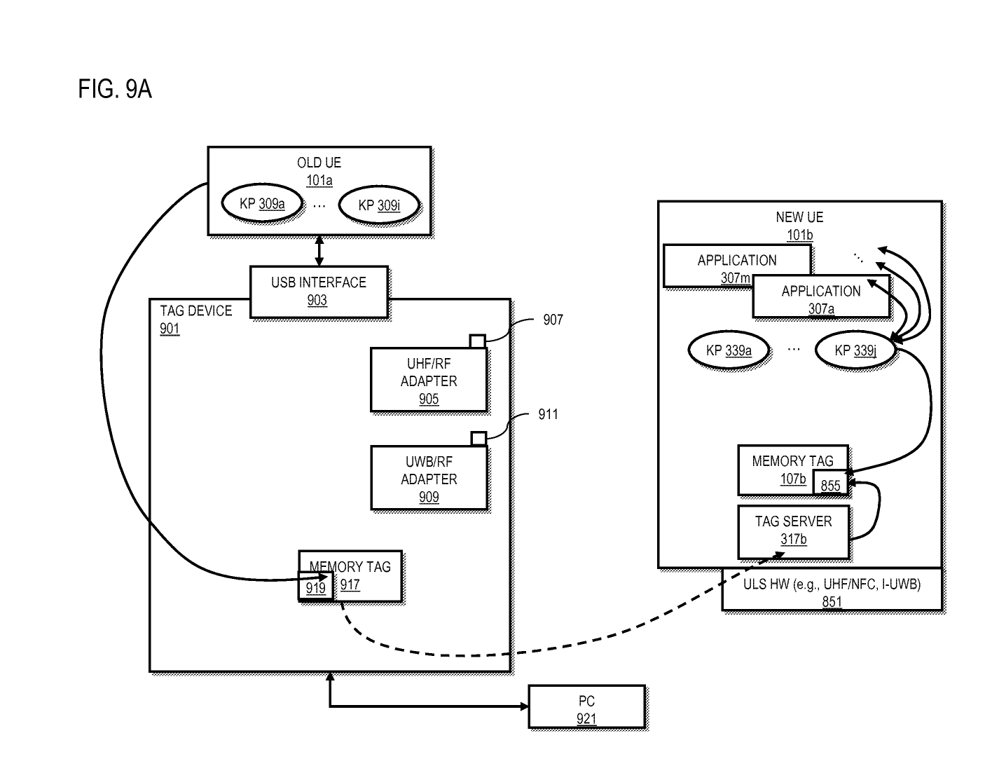

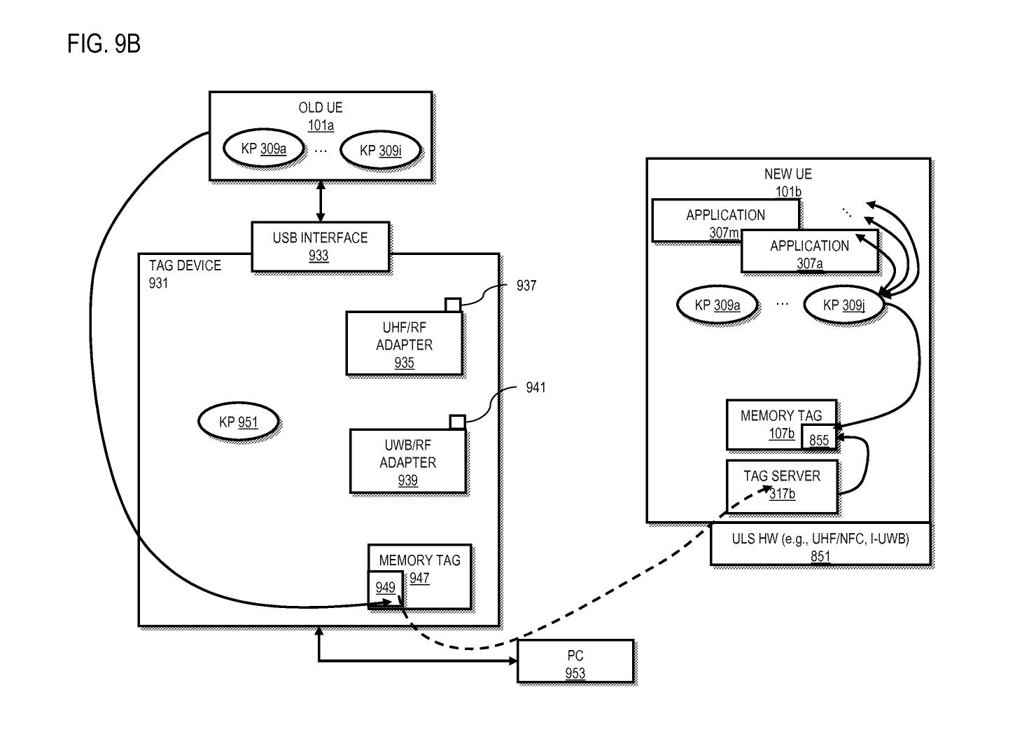

FIGS. 9A-9B illustrate utilization of an external storage for efficiently managing content, configuration and credentials among devices, according to various embodiments. In some embodiments, the old UE 101a may not be equipped with a tag memory 107. In such a case, an external device may be connected to the old UE 101a through, for example, a USB port to provide the UE 101a with capabilities of a memory tag 107 and server 317. In FIG. 9A, an external device 901 can be accessed by the UE 101 through the USB interface 903 (or other external device connection or interface) and used for the processes performed by the internal memory tag 107a and the tag server 317. In one embodiment, memory space 917 can be used as an alternative to the memory tag 107a. For example, the aggregated information is stored in memory 917 and subsequently transferred to the new UE 101b. Alternatively, the external tag device 901 may be attached to a PC 921, and its content can be transferred to the information space 109 or to a backup storage device through the PC 921.

FIG. 9B illustrates another embodiment where the external tag device 931 is equipped with one or more knowledge processors 951. In some embodiments, it is contemplated that the approach described herein may be performed by an external tag device 931 equipped with one or more knowledge processors 951. For example, such an external tag device 931 can be used to supplement or act in place of the knowledge processors 309 of the UE 101 that is initiating a transfer operation (e.g., the old UE 101a). In certain embodiments, the old UE 101a may not include a knowledge processor 309 or other component capable of performing the transfer process. In this case, the old UE 101a can rely on the external device 931 to perform the process. In other words, the external tag device 931 can function as the knowledge processor 309 and memory tag 107 for the old UE 101a. By way of example, the old UE 101a can be connected to the external tag device 931 through an interface such as the USB interface 933. The external tag device 931 manages the transfer of content, configurations and credentials backup and synchronization to and from the information transferability manager 103 from and to the old UE 101a. For example, the aggregated information can be transferred from the old UE 101a's memory to the external tag device 931. The external tag device 931 may communicate and send or receive information with the new UE 101b through one or more of the Ultra High Frequency/Near Field Communication (UHF/NFC) 935 and/or the Impulse based Ultra Wideband (I-UWB).

The knowledge processor 951 of the external device 931 reconstitutes the aggregated information (e.g., content, configuration, and credentials) on the new UE 101b following the transfer of aggregated information from the external tag device 931 to the memory 855 part of the memory tag 107b of the new UE 101b.

In one embodiment, both the old and the new UEs 101a and 101b may not be equipped with tag memories. In such case, each UE 101 may be connected to an external tag device 931 to perform the transfer process.

The external tag device 931 may be, for instance, a memory stick including a knowledge processor 951 to provide the logic and processing power to the perform the functions of the knowledge processor 309 described with respect to the UE 101. The knowledge processor 951 is capable of storing the information from the old UE 101a into the external tag 931 or directly into the storage associated with the information space 109. Alternatively, if the old UE 101a is equipped with knowledge processors 309, the knowledge processors 309 of the old UE 101a can perform requested transfer operations (e.g., incremental updates) to the information space 109 while storing only parameters and other related information for initiating the transfer operation (e.g., restoring from the backup and/or synchronization) from the information space 109 when the external tag device 931 is attached to the new UE 101b.

As another alternative, following the storage of aggregated information in the memory of the external tag device 931, the external tag device 931 can be connected to a PC 953 to transfer the stored content, configuration and credentials transferred to the information space 109 associated with the specific user or device. In this embodiment, the information space 109 may check the availability of a new UE 101b periodically (e.g., by determining whether the new UE 101a has joined the information space 109 as a node). When a new UE 101b is available, the information space 109 can initiate the transfer and reconstitution of the aggregated information in the new UE 101b as discussed in FIG. 7.

FIGS. 10A-10C illustrate utilization of information transfer among devices for backup and synchronization, according to various embodiments. In one embodiment the process of synchronization or backup may be performed incrementally. The old UE 101a in FIG. 10A may be equipped with an internal or an external tag device 1005. The old UE 101a may synchronize its content, configuration and credentials, or a subset of the content, configuration and credentials, with the information space 109a (shown as arrow 1007). The incremental update tag device 1005 that has connectivity to the old UE 101a and the information space 109a checks the old UE 101a's account in the information space 109a. The incremental update tag device 1005 reads the content, configuration and credentials of the old UE 101a from the old UE 101a (shown as arrow 1013). The incremental update tag device 1005 may then compare the information from the information space 109a with the information from the old UE 101a. If there are local changes in the information at the old UE 101a that have not been reflected in the of the information space 109a, the incremental update tag device 1005 may directly update the information space 109a if it is feasible or send a backup or synchronization request to the information transferability manager 103.

The incremental update tag device 1005 may also incrementally update the information in the new UE 101b using the information from the old UE 101a and/or the information space 109a (shown as arrow 1015). The incremental update tag device 1005 may also update the information space 109b using the information from the old UE 101a and/or the information space 109a and the details about the new UE 101b including the configuration, available applications, knowledge processors, etc.

In the embodiment depicted in FIG. 10B, the incremental update tag device 1005 and the information space 109a are part of a distributed service platform 1021. In this embodiment, part of the functionality of the incremental update tag device 1025 can be located within the scope of the information space 109a. Furthermore, copies of the content, configuration and credentials of the old UE 101a exist on both sides of the distributed service platform 1021. This feature enables the predictive backup and synchronization of the content, configuration and credentials for an ordered new UE 101b. For example a user may select a new UE (from an online catalog, in the store, etc.), place an order and at the same time start the process of backup and synchronization of the content, configuration and credentials of the old UE 101a using user account on the information space 109a associated with the old UE 101a. The information may be available to the retailer so that the retailer can transfer the information to the new UE 101b and initialize user services on the new UE 101b before the new UE 101b is delivered to the user. In this embodiment, the user may sign an agreement with the retailer at purchase point to give the retailer permission for accessing user's account on the information space 109a.

The embodiment of FIG. 10C depicts an example where several elements for information backup and synchronization are available. As shown in FIG. 10C, an old UE 101a is attached to an external tag device 901 and a PC 1043. In this embodiment the incremental update tag device 1041 has access to the old UE 101a, the information space 109a, the tag device 901, the PC 1043 and the new UE 101b. In this embodiment, the incremental update tag device 1041 can keep track of the updates in any of the components it is connected to and with every detected change, update the information on the new UE 101b accordingly.

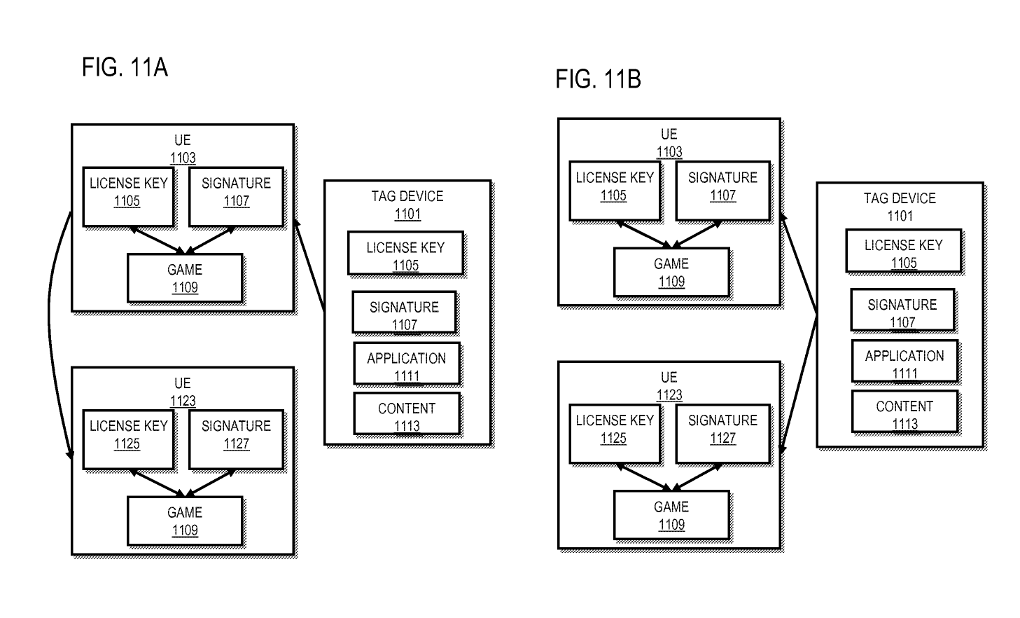

FIGS. 11A-11B illustrate tag based license management, according to various embodiments. In one embodiment, the approach described herein enables different application providers to implement different installation schemes for their respective applications on devices. For example, these installation schemes may be used to provide a flexible model for sharing royalties or license fees. More specifically, this capability relies on an approach where a UE 101 obtains a signature representing the respective licenses to enable downloading or obtaining of applications from either a web service or from an off-the-band service endpoint.

In one embodiment, a tag device 1101 contains the required credentials (e.g. a license key) for application activation. In order to protect the business interest of the vendor, the device tag 1101 generally is protected from re-use by other devices. Depending on the application, the tag device 1101 may turn into a demonstration tag following initial use. In other words, a first device may access the tag device 1101 to obtain the credentials for full access. Then, subsequent access by other devices can result in provision of, for instance, a limited demonstration version of the application or content. The creation of the signed applications offers the possibilities to find the qualitative properties of the applications and to maintain the initially given security information in a more efficient format (i.e., signatures). The utilization of the signatures delivers manageable security infrastructure of the applications, especially in a highly evolving distributed tagging system and within information space architectures. Referring back to FIG. 1, the UE 101a-101n, and all the other platforms having connectivity through the communication network 105 may have respective signature application infrastructures and databases for storing signatures and corresponding semantic information (not shown).

According to the presented approach, all applications are optionally signed by authorized entity and delivered either through off-the-band sales points or by web service providers. The signatures are checked by local signature infrastructure in order to detect any disparity between the device specific signature infrastructure and application signature. Since the very first delivery is considered as “one license used” step by security infrastructure, the corresponding signature is updated locally in order to aggregate license counter. The signatures infrastructure is designed so that the originally synthesized signature is created according to the predetermined valid licenses. The mechanism of updates is modifying original signature in order to reflect “less one license” state.

In one embodiment, a tag capable UE 101 or other tag compliant UE 101 (e.g. attached with external tag devices) may not run or install an encrypted application until a tag device 1101 or other memory tag 107 with a signed key allowing the running of the application is brought within close proximity of the UE 101 for authentication. For example, UEs 101 operating within an information space infrastructure generally contain a signature manager application controlling or managing applications that require a signature in order to validate a license key. The signature manager application also can maintain a list of license keys obtained. The user interface of the information space/tag based UEs 101 can show an application that is not ready for execution (e.g., is still encrypted because a valid license key has not yet been applied) in a way that allows users to view the application, but not execute it. If the user tries to use such an application, the signature manager notifies the user to supply a valid license tag.

In case a signature is not presented at the first instance of running an application, the application may not start or can notify that only limited demonstration mode is possible. The application will only be permanently available on the devices after reading an application tag containing the necessary signature to authorize execution of the full application. For example, each tag may contain a signature tailored for the commercial and demostration purposes which that is protected from normal writing. The information space/tag based UE software reads the signature with license key from the tag. Thereafter, the UE 101 updates the signature of the license key within its local signature infrastructure database so that no other device may be able to use the signature with the same key. When a tag with signature is read by another device, it may only be served with either the signature with demostration key or service could be denied.

In one embodiment, the application from the software vendor installed on a UE 101 is signed (within signature infrastructure) so that it cannot be taken off of the UE 101 for backwards engineering and breaking of the signature or license key mechanism. This signing also prevents the application from being tampered by a malicious third party. The process of using signatures for gaining access to content information is as follows: A user purchases content (e.g. music, eBook, etc.) via a UE 101 (e.g. a PC, mobile phone, etc.). The server ties the purchased content to the user account. The UE 101 connects with the store backend to synchronize the content. Following the synchronization the purchased content is indicated to the UE 101. The signature infrastructure signs the content. Once the signature is received by the seller server, the content will be delivered based on the sale agreement (e.g. online download, email attachment, etc.). Once the content is received, the signature infrastructure validates the user's signature once again before transferring the content from the endpoint (tag) to the device memory and installing the content. The signature manager refreshes the list of content (including the newly installed content) and updates the signatures database.

In the examples of FIGS. 11A-11B signature are processed by activation and decryption of a game application 1111. In FIG. 11A, the UE 1103 downloads the license key 1105 to the game 1109 that the UE may have preinstalled, or the UE may download also the game application 1111 for game 1109 from the tag device 1101. The downloaded license key 1105 and content 1113 may then be copied from UE 1103 to UE 1123 together with the updated signature process, if allowed. In this case, the two UEs 1103 and 1123 may have different signature values since the UE 1103 may update the signature before copying the content and license key to the UE 1123.

However, FIG. 11B depicts a different scenario where UE 1103 and UE 1123 both download the license key to game 1109 that they may have preinstalled or otherwise downloaded from tag device 1101. In this case, both of the UEs will have the same signature value as specified by the tag device 1101.

The processes described herein for efficiently managing content, configuration and credentials among devices may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

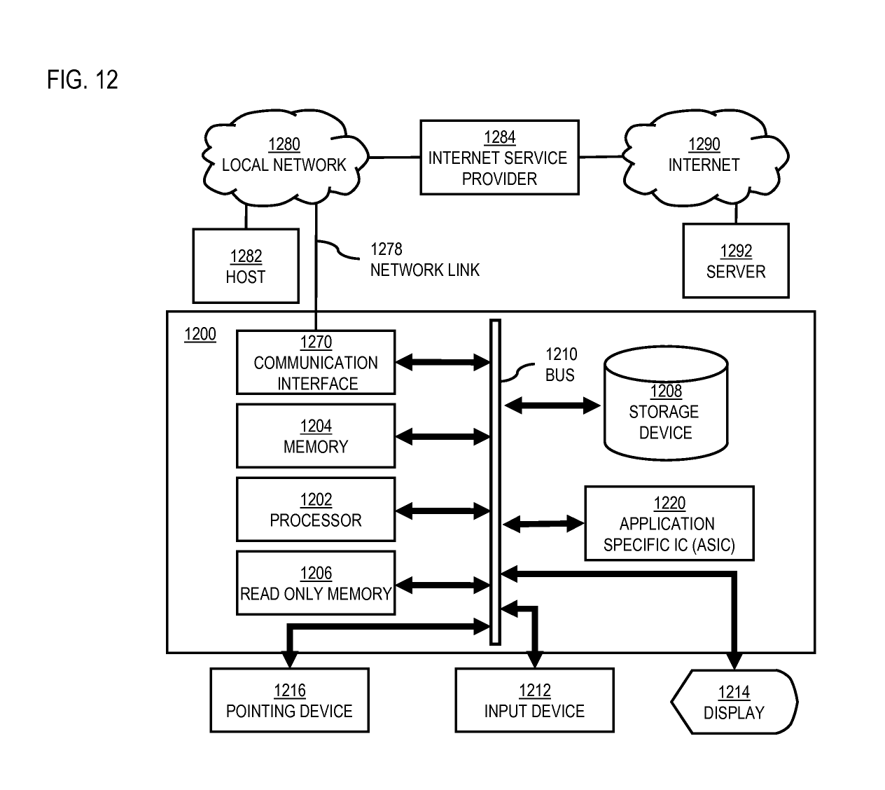

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to provide transferable content, configuration and credentials as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of efficiently managing content, configuration and credentials among devices.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to efficiently managing content, configuration and credentials among devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for efficiently managing content, configuration and credentials among devices. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for efficiently managing content, configuration and credentials among devices, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 105 for efficiently managing content, configuration and credentials among devices to the UE 101a-101n.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set 1300 upon which an embodiment of the invention may be implemented. Chip set 1300 is programmed to provide transferable content, configuration and credentials as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1300, or a portion thereof, constitutes a means for performing one or more steps of efficiently managing content, configuration and credentials among devices.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide transferable content, configuration and credentials. The memory 1305 also stores the data associated with or generated by the execution of the inventive steps.

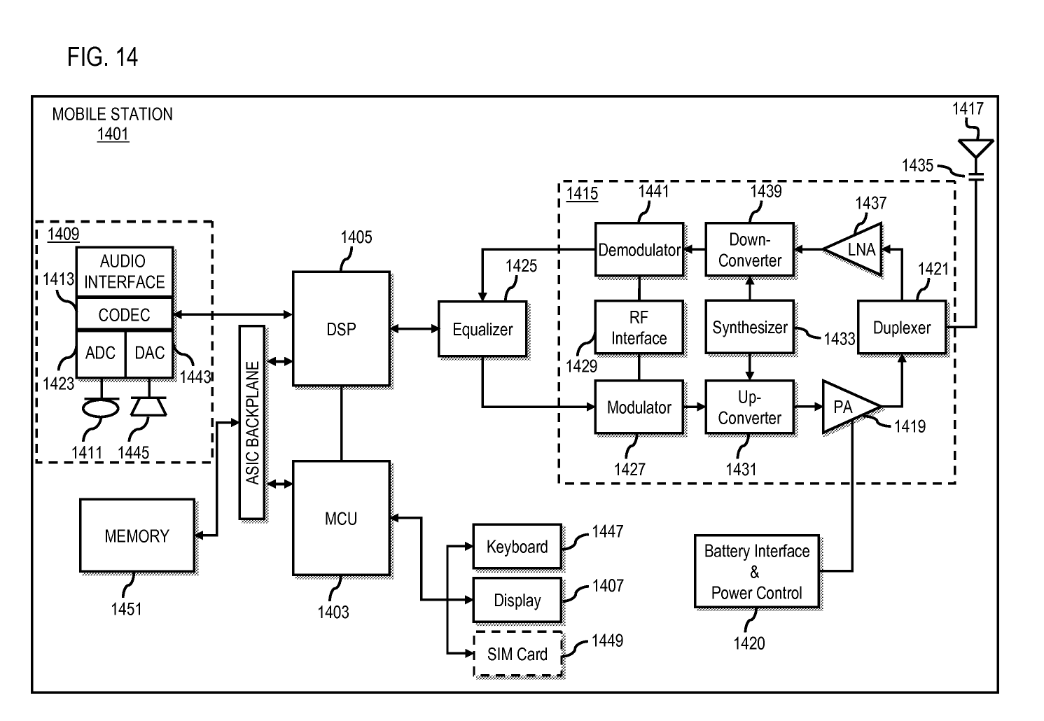

FIG. 14 is a diagram of exemplary components of a mobile terminal (e.g., handset) for communications, which is capable of operating in the system of FIG. 1, according to one embodiment. In some embodiments, mobile terminal 1400, or a portion thereof, constitutes a means for performing one or more steps of efficiently managing content, configuration and credentials among devices. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of efficiently managing content, configuration and credentials among devices. The display 14 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403—which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to provide transferable content, configuration and credentials. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining information and related metadata associated with one or more devices available in an information space, wherein the information includes content, configuration, credentials, or a combination thereof of the one or more devices;
causing, at least in part, aggregation of the determined information and related metadata; and
causing, at least in part, storage of the aggregated information and related metadata in a memory tag.

2. A method of claim 1, further comprising:
causing, at least in part, transfer of the aggregated information and related metadata via the memory tag to one or more other devices.

3. A method of claim 1, further comprising:
causing, at least in part, deletion of the aggregated information and related metadata from the one or more devices.

4. A method of claim 1, wherein the determination and aggregation of the information and related metadata is performed periodically, incrementally, by request, or a combination thereof.

5. A method of claim 1, wherein the credentials include one or more license keys to activate the content, configuration, or combination thereof on the one or more other devices, and the memory tag is an embedded memory tag, an external memory tag, or a combination thereof.

6. An apparatus comprising:
at least one processor; and
at least one memory including computer program code,
the at least one memory and the computer program code configured to, with the at least one processor, cause the apparatus to perform at least the following,
determine information and related metadata associated with one or more devices available in an information space, wherein the information includes content, configuration, credentials, or a combination thereof of the one or more devices,
cause, at least in part, aggregation of the determined information and related metadata, and
cause, at least in part, storage of the aggregated information and related metadata in a memory tag.

7. An apparatus of claim 6, wherein the apparatus is further caused to:
cause, at least in part, transfer of the aggregated information and related metadata via the memory tag to one or more other devices.

8. An apparatus of claim 6, wherein the apparatus is further caused to:
cause, at least in part, deletion of the aggregated information and related metadata from the one or more devices.

9. An apparatus of claim 6, wherein the determination and aggregation of the information and related metadata is performed periodically, incrementally, by request, or a combination thereof.

10. An apparatus of claim 6, wherein the credentials include one or more license keys to activate the content, configuration, or combination thereof on the one or more other devices, and the memory tag is an embedded memory tag, an external memory tag, or a combination thereof.

11. A method comprising:
causing, at least in part, reading of information and related metadata from a memory tag, wherein the information includes content, configuration, credentials, or a combination thereof aggregated from an information space associated with one or more devices;
causing, at least in part, extraction of the content, configuration, or credentials from the information and related metadata; and
causing, at least in part, reconstitution of the extracted content, configuration, and credentials in the information space or another information space associated with one or more other devices, wherein the reconstitution is based at least in part on capabilities of the one or more other devices, the credentials, or a combination thereof.

12. A method of claim 11, wherein the reconstitution comprises:
determining one or more applications associated with the extracted content;
retrieving one or more license keys associated with the one or more determined applications; and
causing, at least in part, installation of the one or more determined applications on the one or more other devices based at least in part on the retrieved one or more license keys.

13. A method of claim 11, further comprising:
determining compatibility of the information and related metadata with the one or more other devices; and
based on the determination, causing, at least in part, wrapping of one or more incompatible portions of the information and related metadata with an adaption wrapper, wherein the adaptation wrapper provides for compatibility of the one or more incompatible portions.

14. A method of claim 13, wherein the adaptation wrapper provides for instruction level virtualization, translation of the one or more incompatible portions, or a combination thereof.

15. A method of claim 14, wherein the memory tag is an embedded memory tag, an external memory tag, or a combination thereof.

16. An apparatus comprising:
at least one processor; and
at least one memory including computer program code,
the at least one memory and the computer program code configured to, with the at least one processor, cause the apparatus to perform at least the following,
cause, at least in part, reading of information and related metadata from a memory tag, wherein the information includes content, configuration, credentials, or a combination thereof aggregated from an information space associated with one or more devices;
cause, at least in part, extraction of the content, configuration, or credentials from the information and related metadata; and
cause, at least in part, reconstitution of the extracted content, configuration, and credentials in the information space or another information space associated with one or more other devices, wherein the reconstitution is based at least in part on capabilities of the one or more other devices, the credentials, or a combination thereof.

17. An apparatus of claim 16, wherein the reconstitution causes the apparatus to:
determine one or more applications associated with the extracted content;
retrieve one or more license keys associated with the one or more determined applications; and
cause, at least in part, installation of the one or more determined applications on the one or more other devices based at least in part on the retrieved one or more license keys.

18. An apparatus of claim 16, wherein the apparatus is further caused to:
determine compatibility of the information and related metadata with the one or more other devices; and
based on the determination, cause, at least in part, wrapping of one or more incompatible portions of the information and related metadata with an adaption wrapper, wherein the adaptation wrapper provides for compatibility of the one or more incompatible portions.

19. An apparatus of claim 16, wherein the adaptation wrapper provides for instruction level virtualization, translation of the one or more incompatible portions, or a combination thereof.

20. An apparatus of claim 16, wherein the memory tag is an embedded memory tag, an external memory tag, or a combination thereof.
